(19) United States
(12) Patent Application Publication
(10) Pub. No.: US 2012/0241106 A1
(43) Pub. Date: Sep. 27, 2012

(54) VERTICAL BLIND RETROFIT SYSTEM

(75) Inventors: Alice Bolton, Providence, RI (US); Christine Trucchi, West Bridgewater, MA (US)

(73) Assignee: Corona Curtain Manufacturing, West Warwick, RI (US)

(21) Appl. No.: 13/424,004

(22) Filed: Mar. 19, 2012

Related U.S. Application Data
(60) Provisional application No. 61/466,483, filed on Mar. 23, 2011.

(51) Int. Cl. E06B 9/36; B23P 6/00; E06B 9/386

(52) U.S. Cl. 160/166.1; 160/236; 29/402.01

(57) ABSTRACT

A curtain panel is provided for use in retrofitting vertical blinds. The curtain panel is configured to hang in place of vertical blind slats as a retrofit application that provides a greatly improved appearance as compared to traditional vertical blinds. In general the curtain panel employs a system of buttonholes along a top edge of the panel to affix it in place on the same hook system where the vertical slat deteriorating blinds were formerly held in place. In this manner a retrofit is offered as a fashionable option to ugly blinds. The user also has the ability to coordinate a patio door (sliding glass door, etc.) panel to his/her interior decor.

### CROSS-REFERENCE TO RELATED APPLICATIONS

This application is related to and claims priority from earlier filed U.S. Provisional Patent Application No. 61/466,483 filed Mar. 23, 2011.

### BACKGROUND OF THE INVENTION

The present invention relates to a curtain for use in retrofitting vertical blinds to provide an improved and contemporary appearance. More specifically, the present invention relates to a curtain panel that is configured to hang in place of vertical blind slats as a retrofit application that provides a greatly improved appearance as compared to traditional vertical blinds.

In the prior art, a conventional vertically extending Venetian blind generally includes a head rail, a plurality of carrier slides slidable along the head rail in a longitudinal direction, and a plurality of slats, each of which hangs from a respective one of the carrier slides. When the blind is in a closed position, the slats are extended such that they are distributed across the opening and rotated to be aligned substantially parallel with one another to block incoming light. The carrier slides on to which each of the slats is mounted is rotatable within a predetermined angular range about a pivot axis so as to allow a user to control the relative angle at which all of the slats are pivoted and regulate the amount of the light blocked by the slats. Further, the carriers can be slid to one end of the head rail thereby placing the blind in an open position wherein all of the slats are stacked at the end(s) of the head rail.

The appearance of such blinds is quite limited and is restricted to the appearance of the slats. Such slats often get dirty over time creating a problem in that they are difficult to clean effectively. Further, slats become bent or broken in a manner that causes the blind to have an uneven or non-uniform appearance. Still further, such traditional vertical blinds do not hang in a manner that is always consistent and when they are rotated to allow light into a room they provide no screening over the window or door.

A current popular feature that attempts to overcome the noted shortcomings is to integrally form the vanes with a cover that extends between the vanes so as to diffuse incoming light and to provide an aesthetically pleasing appearance. One popular vane cover design is the u-shaped or scalloped design in which the cover forms folds between the vanes that extend in outward direction towards the viewer. Such covers typically include vanes made of a stiff fabric that are integrally attached together with strips of sheer fabric. One problem with such covers is that the material used to form the cover is expensive, and the manufacturing cost for the covers is likewise expensive. Furthermore, the stiffening and sheer fabrics are not washable in conventional washing machines. If washed in a conventional washing machine, the fabrics in the cover would be destroyed by the washing process. The washing process bends the stiffening fabric such that the stiffening vanes are no longer straight after washing. Another problem faced with the integral cover design is that the stiffening fabric does not have enough weight in order to counter balance the weight of the u-shaped folds. This creates an undesirable “swooped back” look in which the cover angles back towards the window. Moreover, retrofitting an integral system to pre-existing vertical blind systems can be quite expensive.

In view of the above noted shortcomings with the traditional vertical blinds, there is a need for a curtain for use in retrofitting vertical blinds to provide an improved and contemporary appearance. There is a further need for a curtain panel that is configured to hang in place of vertical blind slats as a retrofit application that provides a greatly improved appearance as compared to traditional vertical blinds.

### SUMMARY OF THE INVENTION

In accordance with the present invention a curtain is provided for use in retrofitting vertical blinds to provide an improved and contemporary appearance. The curtain panel of the present invention is configured to hang in place of vertical blind slats as a retrofit application that provides a greatly improved appearance as compared to traditional vertical blinds. In particular, the panel was invented to replace ugly blind slats in their entirety when they become dirty or broken. Instead of a customer having to purchase replacement blinds, the track panel allows the customer to have a more fashionable option, by being able to hang a coordinating window drape in whatever room has the sliding glass door or patio door entryway, etc. where a vertical blind system is generally used.

In general the curtain panel of the present invention employs a system of buttonholes along a top edge of the panel to affix it in place on the same hook system where the vertical slat deteriorating blinds were formerly held in place. In this manner a retrofit is offered as a fashionable option to ugly blinds. The user also has the ability to coordinate a patio door (sliding glass door, etc.) panel to his/her interior decor.

The vertical blind slats are removed from the horizontal carrier. The buttonholes that are stitched along the top of the track panel allow the track panel to hang from the existing hook system of the track panel already in place. The buttonhole openings are slid over the existing clips for easy installation by the customer. The stitched buttonholes are reinforced from behind with a strip of vinyl for extra stability.

Accordingly, it is an object of the present invention to provide a curtain device having curtain units that can be easily and removably installed onto vertically extending Venetian blind slat supports within a vertical blind track system. The fabric material for the curtain units can vary so as to replace the slats within a Venetian blind without affecting basic operation of the latter.

### BRIEF DESCRIPTION OF THE DRAWINGS

In the drawings which illustrate the best mode presently contemplated for carrying out the present invention:

FIG. 1 depicts a prior art vertical blind system;

FIG. 2 depicts the installation of the vertical blind retrofit system of the present invention; and

FIG. 3 depicts a completed installation using the present invention.

### DETAILED DESCRIPTION OF THE INVENTION

Now referring to the drawings, the vertical blind retrofit system is shown and generally illustrated in the figures. As can be seen the principal component of the retrofit system is a tailored fabric panel that is configured and arranged to replace the vertical slats of the vertical blind system.

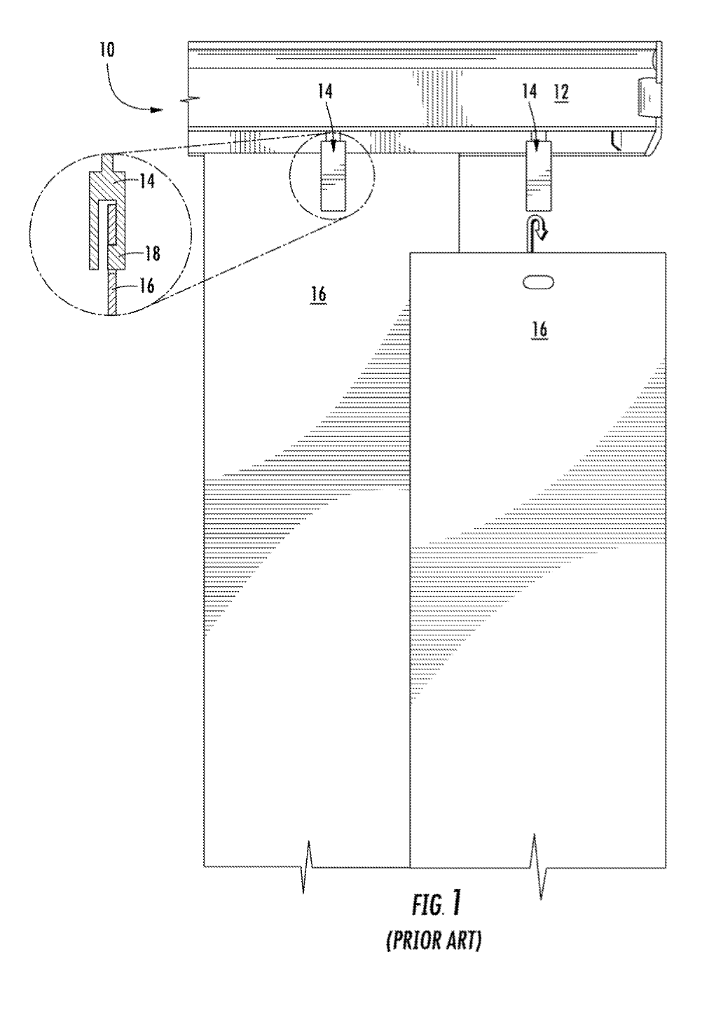

As can be seen at FIG. 1 a prior art vertical blind system is shown to include a head rail 12, carrier supports slidably 14 received within the head rail 12 and vertical slats 16 supported by sliding carrier supports 14. When the blind is in a closed position, the slats 16 are extended such that they are distributed across the opening and rotated to be aligned substantially parallel with one another to block incoming light. The carrier slides 14 on to which each of the slats 16 is mounted is rotatable within a predetermined angular range about a pivot axis so as to allow a user to control the relative angle at which all of the slats are pivoted and regulate the amount of the light blocked by the slats 16. Further, the carrier slides 14 can be slid to one end of the head rail 12 thereby placing the blind in an open position wherein all of the slats 16 are stacked at the end(s) of the head rail. In the detail inset it can be seen that the carrier slide 14 further includes a hook 18 that supports and retains the vertical slat 16.

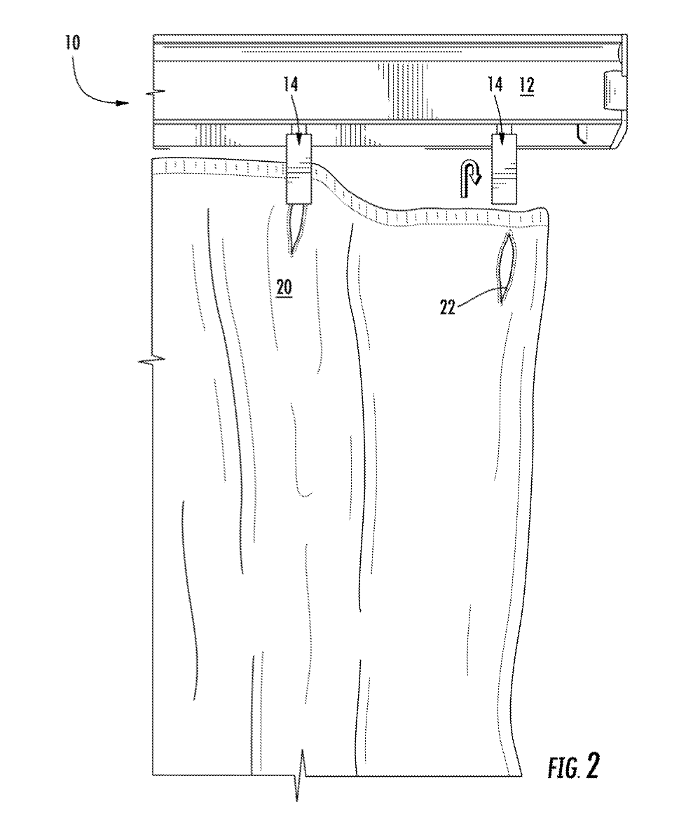

As depicted at FIG. 2, in accordance with the present invention a curtain panel 20 is provided for use in retrofitting vertical blinds to provide an improved and contemporary appearance. In this regard the vertical slats 16 are removed from the carrier slides 14 and the curtain panel 20 of the present invention is configured to hang in place of vertical blind slats 16 as a retrofit application. This arrangement provides a greatly improved appearance as compared to traditional vertical blinds.

In general the curtain panel 20 of the present invention employs a system of buttonholes 22. The buttonholes 22 are spaced apart along the top edge of a tailored curtain panel 20 to correspond to the traditional spacing of the carrier slides 14 of the vertical blind system. In this manner the buttonholes 22 along a top edge of the panel 20 to affix it in place on the same carrier slides 14 and the same hook 18 where the vertical slat blinds were formerly held in place. In this manner a retrofit is offered as a fashionable option to ugly blinds. The user also has the ability to coordinate a patio door (sliding glass door, etc.) panel to his/her interior decor.

In order to install the retrofit panel of the present invention, the vertical blind slats 16 are removed from the head rail 12 and carrier slides 14. The buttonholes 22 that are stitched along the top of the track panel 20 allow the track panel 20 to hang from the existing carrier system already in place. The buttonhole 22 openings are slid over the existing carriers 14 and onto the hooks 18 for easy installation. The stitched buttonholes 22 are reinforced from behind with a strip of vinyl for extra stability.

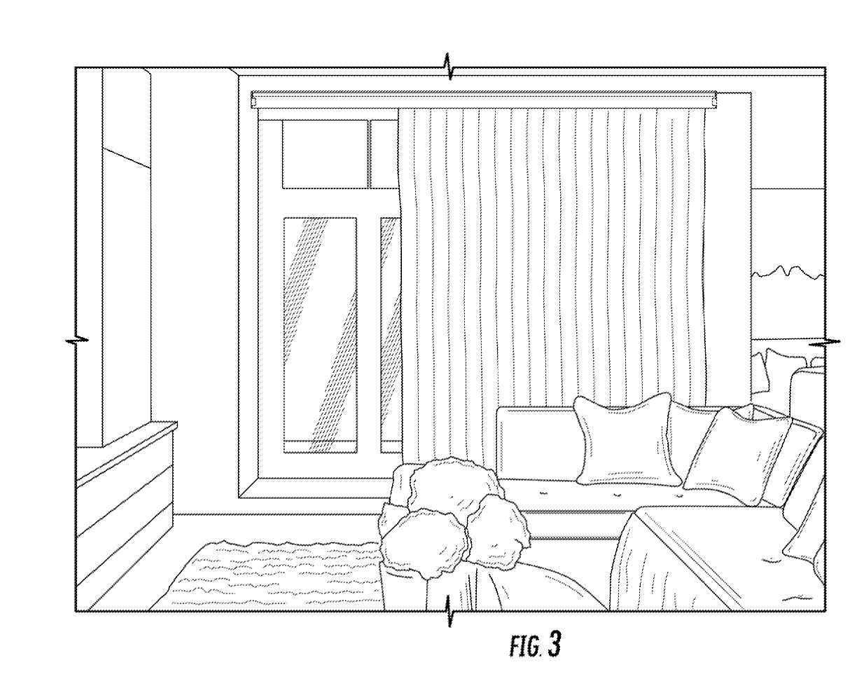

As can be seen at FIG. 3 the completed installation depicts a drape panel that is fully supported by the carrier head rail and carrier slides of the vertical blind system wherein the vertical slats are removed. The slide system remains fully operational with the retrofit panel in place. The fabric panel can offer (but is not limited to) insulating characteristics as well. Most tightly woven fabrics would be usable for this item. Fabrics that could be back coated with a foam backing to offer insulation to prevent heat loss through the glass patio sliding glass or paneled glass doors. A flock or acrylic foam substrate adds the insulating factor and is generally applied to the back of the fabric. The panel could be formed from a variety of fabrics, all to add a home decor feature, in place of the more utilitarian blind system. While the panel may be insulated or light blocking, it could also offer an airy look by using a variety of sheer fabrics for example. The same technique of application would be employed.

It can therefore be seen that the present invention provides a retrofit curtain panel that can be easily and removably installed onto vertically extending vertical blind slat supports. The fabric material for the panels units can vary so as to replace the slats without affecting basic operation of the system. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A drape panel, comprising:
a textile panel having a top edge; and
a plurality of spaced apart button holes along said top edge,
wherein said button holes are configured and arranged to engage with carriers in a vertical blind track system.

2. The drape panel of claim 1, further comprising:
a vinyl reinforcing strip at said top edge, said strip reinforcing said button holes.

3. The drape panel of claim 1, said textile panel including a layer on insulation thereon.

4. A drape system comprising, in combination:
a vertical blind system comprising:
a head rail; and
carrier slides supported by said head rail;
a drape comprising:
a textile panel having a top edge; and
a plurality of spaced apart button holes along said top edge,
wherein said button holes are configured and arranged to engage with said carrier slides.

5. The drape system of claim 4, further comprising:
a vinyl reinforcing strip at said top edge, said strip reinforcing said button holes.

6. The drape system of claim 4, said textile panel including a layer on insulation thereon.

7. A method of retrofitting a vertical blind system having a head rail, carrier slides supported by said head rail, and vertical slats supported by said carrier slides, comprising:
removing said vertical slats from said carrier slides;
providing a textile panel having a top edge and a plurality of spaced apart button holes along said top edge, wherein said button holes are configured and arranged to engage with said carrier slides; and
installing said textile panel onto said vertical blind system by engaging said button holes with said carrier slides.

8. The method of claim 7, said textile panel further comprising:
a vinyl reinforcing strip at said top edge, said strip reinforcing said button holes.

9. The method of claim 7, said textile panel including a layer on insulation thereon.
